(19) United States
(12) Patent Application Publication
(10) Pub. No.: US 2016/0345506 A1
(43) Pub. Date: Dec. 1, 2016

(54) PRUNING SHEARS

(71) Applicant: Thomas LIN, TAICHUNG CITY (TW)

(72) Inventor: Thomas LIN, TAICHUNG CITY (TW)

(21) Appl. No.: 15/170,370

(22) Filed: Jun. 1, 2016

(30) Foreign Application Priority Data
Jun. 1, 2015 (TW) 104117595

(51) Int. Cl. A01G 3/02; B26B 13/28

(52) U.S. Cl. CPC A01G 3/021; B26B 13/28

(57) ABSTRACT

A pair of pruning shears includes a handle, a first blade, a second blade, and a controlling unit. The first blade is pivotally connected to an upper end of the handle. The second blade is pivotally connected to the first blade and has a second cutting edge and a second hilt. The second hilt is connected to a lower end of the second cutting edge and has an abutting surface and a series of sockets located opposite to the abutting surface. The controlling unit has a gear and a pushing member. The gear is mounted on handle and meshes with the sockets of the second hilt of the second blade. The pushing member pushes upon the abutting surface of the second hilt of the second blade. Thereby, the first and second blades cut with improved smoothness, and the overall structural strength of the pruning shears is enhanced.

### BACKGROUND OF THE INVENTION

1. Technical Field

The present invention relates to pruning shears, and more particularly to a pair of pruning shears with enhanced structural strength.

2. Description of Related Art

In a known pair of pruning shears invented by the inventor of the present invention and disclosed in Taiwan Patent No. M291207, a movable pivot shaft is configured to engage with sockets located at different sites for changed pivot points, so that a user can apply force in several stages during cutting, thereby achieving labor-saving operation.

However, in addition to inferior operational smoothness, the prior-art device has a problem that the movable pivot shaft tends to get worn when moving between those pivot-point-forming sockets over long-term use. Such structural weakness can shorten the overall service life of the pruning shears.

### BRIEF SUMMARY OF THE INVENTION

The primary objective of the present invention is to provide a pair of pruning shears, which has improved operational smoothness and enhanced structural strength.

For achieving the foregoing objective, the disclosed pruning shears comprise a handle, a first blade, a second blade, and a controlling unit. The first blade includes a first cutting edge and a first hilt. The first cutting edge has its lower end pivotally connected to the handle's upper end. The first hilt has its upper end connected to the first cutting edge's lower end. The second blade is pivotally connected to the first hilt of the first blade and has a second cutting edge and a second hilt. The second hilt is connected to the second cutting edge's lower end and has an abutting surface and a series of sockets located opposite to the abutting surface. The controlling unit has a gear and a pushing member. The gear is rotatably attached to the handle and alternatively meshes with one of the sockets of the second hilt of the second blade. The pushing member presses against the abutting surface of the second hilt of the second blade.

Thereby, the disclosed pruning shears provide improved operational smoothness and enhanced structural strength. With the configuration as described previously, when the handle is pulled away from the first hilt of the first blade, the gear rolls from the upper end of the series of sockets to the lower end of the series of sockets, and at the same time the pushing member pushes abutting surface of the second hilt of the second blade, thereby forcing the second cutting edge of the second blade to leave the first cutting edge of the first blade. On the contrary, when the handle is pushed toward the first hilt of the first blade, the gear rolls from the lower end of the series of the sockets to the upper end of the series of sockets, and at the same time applies a pushing force to the second hilt of the second blade, so as to make the second cutting edge of the second blade come close to the first cutting edge of the first blade.

### BRIEF DESCRIPTION OF THE SEVERAL VIEWS OF THE DRAWINGS

FIG. 1 is a plane view of a first embodiment of the present invention.

FIG. 2, similar to FIG. 1, shows first and second blades are opened to a maximum opening angle.

FIG. 3 is a plane view of a second embodiment of the present invention.

FIG. 4 is a cut-away view of a third embodiment of the present invention.

### DETAILED DESCRIPTION OF THE INVENTION

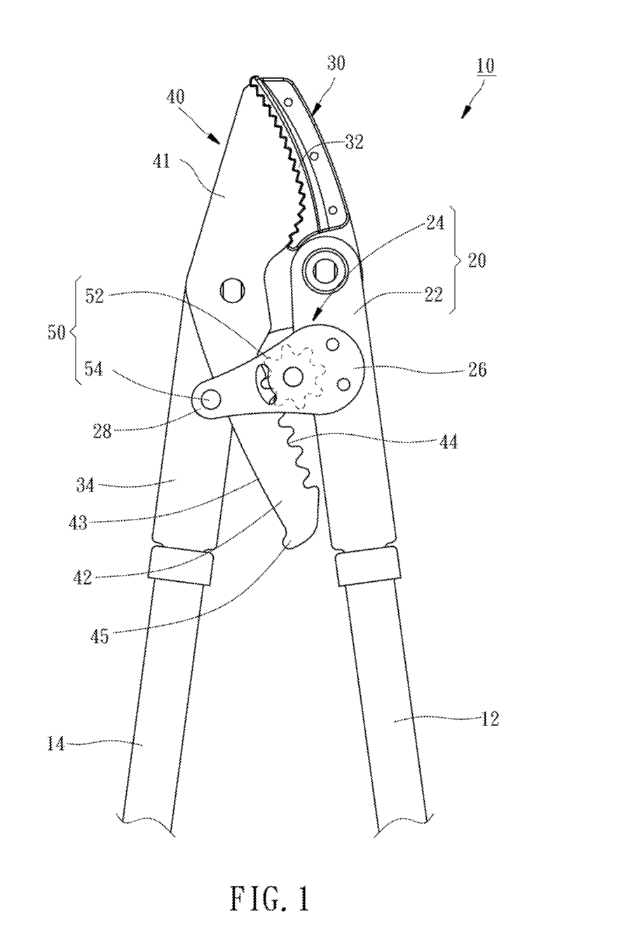

Referring to FIG. 1, according to a first embodiment of the present invention, a pair of pruning shears 10 comprises a handle 20, a first blade 30, a second blade 40, and a controlling unit 50.

The handle 20 in the present embodiment has a handle body 22 and two opposite covers 24. The handle body 22 has its lower end fixed to an upper end of a grip 12. Each of the cover 24 includes a fixed end 26 and an over-hanging end 28. Each of the covers 24 has its fixed end 26 screwed onto an upper end of the handle body 22.

The first blade 30 includes a first cutting edge 32 and a first hilt 34. The first cutting edge 32 has its lower end pivotally connected to an upper end of the handle 20. The first hilt 34 has its upper end angled and connected to the lower end of the first cutting edge 32. The first hilt 34 has its lower end fixed to another grip 14.

The second blade 40 is pivotally connected to the first hilt 34 of the first blade 30 and has a second cutting edge 41 and a second hilt 42. The second hilt 42 is connected to a lower end of the second cutting edge 41 and has an abutting surface 43 and a series of sockets 44 located opposite to the abutting surface 43. In addition, the second blade 40 has a stop member 45. The stop member 45 is located at a lower end of the second hilt 42 and adjacent to the abutting surface 43.

The controlling unit 50 has a gear 52 and a pushing member 54. The gear 52 is located between the two covers 24 of the handle 20 and alternatively meshes with one of the sockets 44 of the second hilt 42 of the second blade 40. The pushing member 54 in the present embodiment is a pin. The pushing member 54 is located at the over-hanging end 28 of at least one said cover 24 of the handle 20 and presses against the abutting surface 43 of the second hilt 42 of the second blade 40.

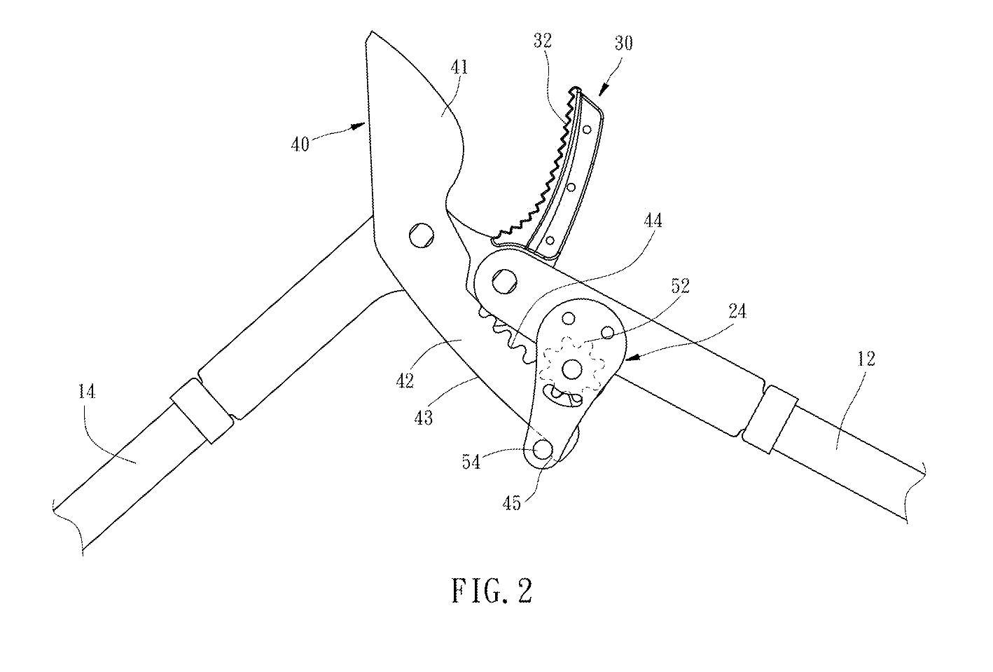

With the configuration as described previously, when the two grips 12, 14 are pulled outward, as shown in FIG. 2, the handle 20 has the cover 24 driving the gear 52 to roll downward along the series of sockets 44 at the second hilt 42 of the second blade 40, and at the same time the handle 20 has the cover 24 driving the pushing member 54 to slide downward along the abutting surface 43 of the second hilt 42 of the second blade 40. As the pushing member 54 is sliding, it applies a pushing force to the second hilt 42 of the second blade 40, so as to make the second cutting edge 41 of the second blade 40 sway away from the first cutting edge 32 of the first blade 30 and form an increasingly opening angle with the first cutting edge 32 of the first blade 30, until the pushing member 54 touches the stop member 45 of the second blade 40, at which point the first cutting edge 32 of the first blade 30 and the second cutting edge 41 of the second blade 40 form the maximum opening angle therebetween.

When the two grips 12, 14 are drawn inward and squeezed together, the handle 20 has the cover 24 driving the gear 52 to roll upward along the series of sockets 44 of the second hilt 42 of the second blade 40, and at the same time the handle 20 has the cover 24 driving the pushing member 54 to slide upward along the abutting surface 43 of the second hilt 42 of the second blade 40. In the process where the gear 52 rolls, it presses against the walls of the sockets 44, so that the second cutting edge 41 of the second blade 40 sways toward the first cutting edge 32 of the first blade 30, until the gear 52 reaches the upper end of the series of sockets 44, as shown in FIG. 1, the first cutting edge 32 of the first blade 30 and the second cutting edge 41 of the second blade 40 contact each other.

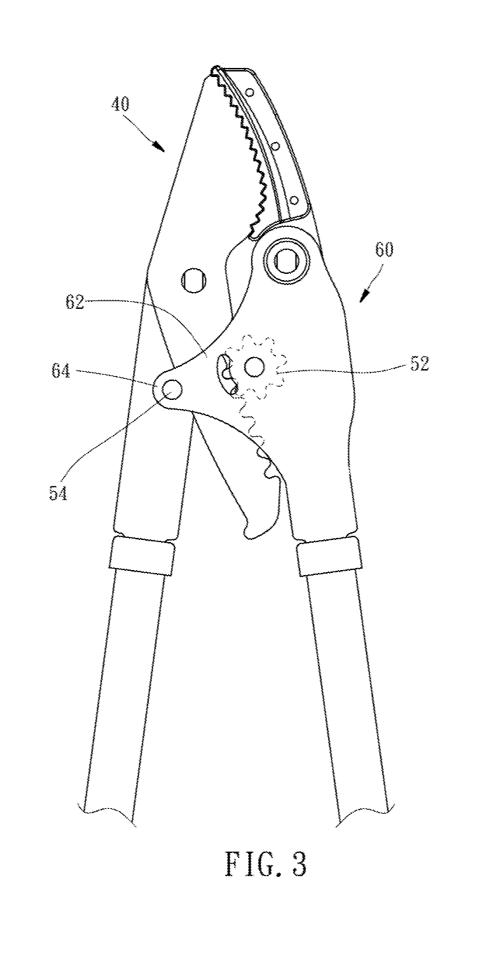

It is to be noted that the present invention may be realized using different structures. As shown in FIG. 3, in a second embodiment, an integrated handle 60 has two taper portions 62 projecting toward the second blade 40, and a gear 52 is rotatably settled between the two taper portions 62 while a pushing member 54 is provided at a tip 64 of at least one of the two taper portions 62, thereby simplifying the structure of the first embodiment.

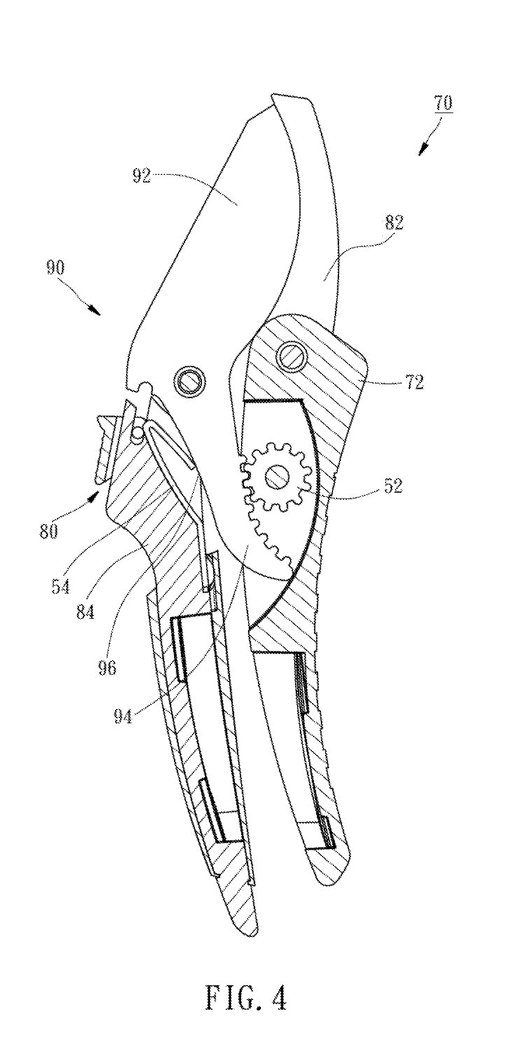

The controlling unit 50 is applicable to other types of pruning shears 70 (such as a pair of flower scissors as shown in FIG. 4). In the depicted third embodiment, the gear 52 is located inside the upper end of the handle 72, while a pushing member 54 is a spring instead of a pin and is located inside the first hilt 84 of the first blade 80. In addition, the pushing member 54 has its one end fixed to the first hilt 84 of the first blade 80 and an opposite end pressing against the abutting surface 96 of the second hilt 94 of the second blade 90, so as to apply a pushing force to the second hilt 94 of the second blade 90 and thereby maintain a separated state between the first cutting edge 82 of the first blade 80 and the second cutting edge 92 of the second blade 90. Thus, a user has to overcome the springiness of the pushing member 54 (i.e. the spring) before the first cutting edge 82 of the first blade 80 and the second cutting edge 92 of the second blade 90 can be drawn together.

To sum up, with the rolling of the gear 52 along the series of the sockets 44 and the pushing force the pushing member 54 applies to the second blade 40, 90, the disclosed pruning shears 10, 70 allow the first and second blades to be opened or closed more smoothly with reduced structural wear, thereby provide enhanced structural strength.

What is claimed is:

1. A pair of pruning shears, comprising:
a handle;
a first blade, having a first cutting edge and a first hilt, the first cutting edge having a lower end pivotally connected to an upper end of the handle, and the first hilt having an upper end connected to the lower end of the first cutting edge;
a second blade, being pivotally connected to the first hilt of the first blade and having a second cutting edge and a second hilt, the second hilt being connected to a lower end of the second cutting edge and having a abutting surface and a series of sockets located opposite to the abutting surface; and
a controlling unit, having a gear and a pushing member, the gear being rotatably attached to the handle and alternatively meshing with one of the sockets of the second hilt of the second blade, and the pushing member pressing against the abutting surface of the second hilt of the second blade.

2. The pruning shears of claim 1, wherein the handle has a handle body and two opposite covers, each said cover having a fixed end and an over-hanging end, each said cover having the fixed end fixed to an upper end of the handle body, the gear being rotatably settled between the two covers, and the pushing member being a pin extending between the over-hanging ends of the two covers.

3. The pruning shears of claim 1, wherein the handle has two opposite taper portions projecting toward the second blade, and the gear is rotatably settled between the two taper portions, in which the pushing member is a pin extending between tips of the two taper portions.

4. The pruning shears of claim 1, wherein the second blade has a stop member provided at a lower end of the second hilt and adjacent to the abutting surface, so as serve to stop the pushing member.

5. The pruning shears of claim 1, wherein the gear rotatably is provided inside the upper end of the handle, and the pushing member is a spring located inside the first hilt of the first blade, in which the spring has one end fixed to the first hilt of the first blade and an opposite end pressing against the abutting surface of the second hilt of the second blade.
